(19) United States
(12) Patent Application Publication
(10) Pub. No.: US 2009/0209401 A1
(43) Pub. Date: Aug. 20, 2009

(54) Flapper roll

(75) Inventor: Deane R. Henderson, Salmon Arm (CA)

Correspondence Address: Antony C. Edwards, P.O. Box 26020, Westbank, BC, V4T 2G3, CA

(73) Assignee: Northern Plastics Ltd.

(21) Appl. No.: 12/071,360

(22) Filed: Feb. 20, 2008

(51) Int. Cl. A01B 29/06

(52) U.S. Cl. 492/30

(57) ABSTRACT

A flapper roll including a resilient substantially cylindrical core and extending radially outwardly therefrom a spaced array of resilient rearwardly cantilevered curved flapper flanges lying in a plane substantially containing a direction of flow of workpieces passing under the roll. The flanges are rearwardly curved relative to a direction of rotation of the roll about a corresponding axis of rotation. The axis is orthogonal to the plane. Each flange may be substantially flat across its width in a direction parallel to said axis so as to substantially evenly distribute across the width a resiliently biased downward force applied to the workpieces passing under the roll. Each flange is compressed as it engages the top surface of its corresponding workpiece to thereby substantially evenly hold down the workpiece and stabilize the workpiece directionally along its intended flow path.

### FIELD OF THE INVENTION

This invention relates to the field of rolls such as hold-down rolls and the like for use in wood processing machinery and in particular to a flapper roll having a plurality of elastically deformable arcuate flanges that are disposed radially about a cylindrical hub.

### BACKGROUND OF THE INVENTION

In many wood processing applications such as in handling panels, and in edgers and the like, it is important to maintain a uniform pressure on a workpiece such as a panel board or flitch as the workpiece is being fed into the processing machinery, and often as the workpiece is also being fed out from such machinery.

For example as identified in U.S. Pat. No. 5,287,782 which issued to Scott on Feb. 22, 1994 for a Gangsaw with Horizontally and Vertically Movable Hold-downs, in the prior art difficulties have been experienced in properly supporting and holding lumber as it moves in the vicinity of saws while the lumber is being cut and in particular difficulties have been experienced in connection with holding down and supporting the ends of a workpiece as it is being cut. Scott explains that a board travelling through a saw is normally held down in regions on opposite sides of where the cut is being made so that as the trailing end of the board travels it moves into a position where it is held down only on the downstream side of the saw arbour and the extreme upstream end of the board is unconstrained free of any hold-down. According to Scott, the action of the saw causes the board to flutter, and may result in tear-out of wood material where the cut is being made and the production of a ragged cut.

The problem of the proper holding down of workpieces such as boards and flitches as they are being cut is complicated by factors which include that individual workpieces may be of various thickness along the length of the workpiece, and that adjacent workpieces on the infeed may have abrupt thickness differences between the adjacent pieces, and that occasionally thinner material may be unsupported as hold-down rolls engage thicker material allowing the thinner material to flutter.

Consequently it is an object of the present invention to provide for the resilient hold-down of workpieces of varying thickness and as between adjacent workpieces of different thicknesses, and in particular to provide an improved resilient roll using a radial array of resilient members protruding from a central hub.

In the prior art, applicant is aware of U.S. Pat. No. 6,199,683 which issued to Michell et al. on Mar. 13, 2001 for a High Speed Revolving Board Singulator with Retracting Shoe and Variable Dwell Duckers in which is disclosed the use of overhead clamping means for gripping boards onto the shoes as the shoes are in motion. The overhead clamping means as disclosed includes an array of radially spaced apart flexible elongate members mounted on a rotatable overhead shaft. The elongate members resiliently clamp so as to pinch a board between one of the resilient elongate members and a board supporting surface on the shoe as the board is translated along the transfer path. It is taught that such resilient clamps may be resilient elongate fingers or shaft-like members. They are substantially linear in their non-deformed position. They engage boards with their distal-most end causing a buckling of the linear resilient member as the board is forced upwardly so as to compress the resilient member along its length as the array of resilient members rotate about their shaft in correspondence with movement of the board on a shoe over its arcuate path.

### SUMMARY OF THE INVENTION

In summary, the flapper roll according to one aspect of the present invention may be characterized as including a resilient substantially cylindrical core and extending radially outwardly therefrom a spaced array of resilient rearwardly cantilevered curved flapper flanges lying in a plane substantially containing a direction of flow of workpieces passing under the roll. The flanges are rearwardly curved relative to a direction of rotation of the roll about a corresponding axis of rotation. The axis is orthogonal to the plane. Each flange may be substantially flat across its width in a direction parallel to the axis so as to substantially evenly distribute across the width a resiliently biased downward force applied to the workpieces passing under the roll. Each flange is compressed as it engages the top surface of its corresponding workpiece to thereby substantially evenly hold down the workpiece and stabilize the workpiece directionally along its intended flow path.

In one embodiment, advantageously the flapper flanges have a hardness in the range of 40-100 Shore A, 40 Shore A for use in some applications where it may be advantageous to use such very soft material. For more conventional applications, the hardness will be in the range of 70-100 Shore A. In one preferred embodiment the hardness is approximately 95 Shore A. Advantageously the flapper flanges may be scimitar-shaped in side elevation profile so as to curve rearwardly relative to the direction of rotation to thereby bring a more horizontally aligned surface of each flange down onto the workpiece as the roll rotates.

Each flange has a base formed with the core and an opposite distal end, opposite the base end. The base end may be thicker than the distal end. The roll has a diameter lying in the plane which extends across the outer circumference of the roll. Each flange has a length extending from and between its opposite ends. That length may be substantially one third of said diameter. The length may be measured as a linear chord length extending from and between the opposite ends.

Each flange may have a curvature profile along the length of each flange relative to the chord. The curvature profile is defined by a maximum thickness between the curvature profile and the chord substantially medially along the curvature. The ratio of the maximum thickness to the length of the chord may be substantially 1:6.

In the array of flanges, base ends of the flanges may abut one another in closely packed array around an outer circumference of the core. The flapper flanges, whether or not scimitar-shaped in side profile, may advantageously taper in the side profile from the base end to an opposite tip end so that a diverging gap is defined between adjacent flanges whereby the tip ends are radially spaced apart from one another. Downstream flanges of the array may thus resiliently bias against a corresponding downstream workpiece passing under, and compressed downwardly by, the roll, and upstream flanges of the array, upstream from and adjacent to the downstream flanges, may engage against a leading edge of an upstream adjacent workpiece, which is upstream and next adjacent to the downstream workpiece, when the upstream workpiece is thicker or thinner than the downstream workpiece.

### BRIEF DESCRIPTION OF THE DRAWINGS

FIG. 1 is, in perspective view, a flapper roll according to the present invention engaging linearly aligned workpieces.

FIG. 1a is the flapper roll of FIG. 1 engaging transversely aligned workpieces.

FIG. 2 is, in side elevation view, the flapper roll of FIG. 1.

FIG. 3 is, in front elevation view, the flapper roll of FIG. 1.

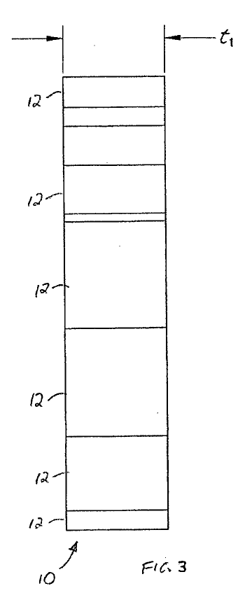

### DETAILED DESCRIPTION OF EMBODIMENTS OF THE INVENTION

In the accompanying drawings wherein similar characters of reference denote corresponding parts in each view, flapper roll 10 includes an equally radially spaced apart array of resilient flapper flanges 12 radially spaced apart on and formed contiguously with a solid resilient cylindrical core 14 itself rigidly mounted onto a steel hub 16.

Core 14, from which flapper flanges 12 protrude, is rigidly mounted onto steel hub 16 by means of a moulded fit and adhesive as would be known to one skilled in the art. Steel hub 16 itself mounts onto a drive shaft or idler shaft (not shown) for simultaneous rotation of flapper roll 10 with rotation of such a shaft by the mating of a key on the shaft with keyway 16a formed along the internal bore 16b of hub 16.

In one embodiment not intended to be limiting: diameter d₁ is 8.75 inches measured diametrically across the outer circumference of the circular array of flanges 12; the outside diameter d₂ of hub 16 is 3 inches; its inside diameter d₃ is 2.44 inches; the roll thickness t₁ is 2 inches; flanges 12, which are each substantially identical, have a base thickness t₂ of substantially 1 inch, a thickness t₃ of the free ends 12b of substantially 0.3 inches; and the nominal radial thickness t₄ of solid core 14 is substantially 0.6 inches; the linear chord length c₁ of the nominal chord length of each flange 12, when measured from the center of the base end 12a to the center of the free end 12b, is 2.9 inches; and the corresponding curvature c₂ of each flange 12 has a maximum thickness t₅ measured between curvature c₂ and chord c₁ of substantially 0.5 inches.

In one embodiment flanges 12 and core 14 are made of a polyurethane having a hardness of 95 Shore A, each flapper roll 10 in the embodiment weighing approximately 2.7 pounds not including the weight of hub 16. Of course, although one embodiment is fully described herein, as would be known to one skilled in the art, the dimensions, hardness and material used may be varied so as to provide a compressible roll that does not have to be translated vertically when engaging each board or flitch (herein described generically as workpieces 18) as those workpieces pass under flapper rolls 10 in direction A as flapper rolls 10 rotate in direction B about axis of rotation C. One object which is accomplished by the flapper roll of the present invention is that it produces a downward pressure on workpiece such as the board or flitch of an improved uniformity so that the board or flitch suffers from reduced deviation from its intended or projected infeed path so as to run truer through the wood processing machine such as an edger (not shown). Further, one of the advantages in this design is that the roll does not have to be actuated up and down to accommodate different thickness. And therefore there is no need for a large gap between work pieces to give the roll time to move into position.

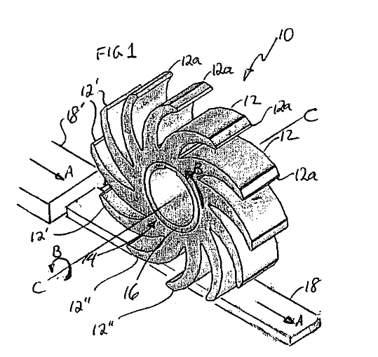

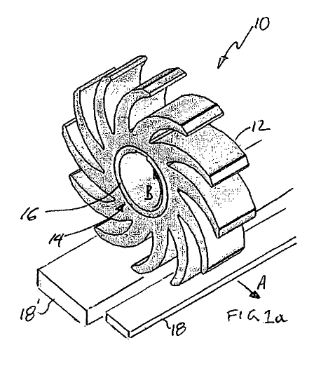

Thus, the uniformity of flanges 12 across each of their widths t₁, and because of the resiliency of each of flanges 12, for example due to a hardness of 95 Shore A, the downward pressure on each workpiece 18 will be spread uniformly laterally across the width of each flapper roll 10, even between adjacent workpieces having differing thicknesses, as a downstream set of adjacent flanges 12″ engages a downstream-most workpiece 18 as adjacent upstream flanges 12′ may readily engage the next adjacent upstream workpiece 18′. It will be seen that as the upstream flanges 12′ rotate along with rotation of roll 10 in direction B, they pass through a substantially horizontal position. Thus the upstream flanges 12′ may readily engage downwardly against the upstream end of a workpiece 18 passing under roll 10 and subsequently engage against the leading edge of the next adjacent upstream workpiece 18′. Because of the relatively long length of each flange 12 (for example ⅓ of the overall diameter of roll 10), and because of the resiliency of each flange 12 (in a hardness range of advantageously 70-100 Shore A), where there are variations in thickness either within a single workpiece 18 or as between a workpiece 18 and an upstream workpiece 18′, each roll 10 will accommodate for variations in thickness of the workpiece without releasing pressure on the downstream workpiece. Thus in the illustrated example of FIG. 1, the downstream workpiece 18 which is present underneath roll 10 is held by the resilient biasing of flanges 12″ and as workpiece 18 translates in direction A, the upstream flanges 12′ engage upstream workpiece 18′ and because workpiece 18′ is thicker than workpiece 18 flanges 12′ will merely flex to a greater degree than flanges 12″ have flexed when resiliently biasing against workpiece 18.

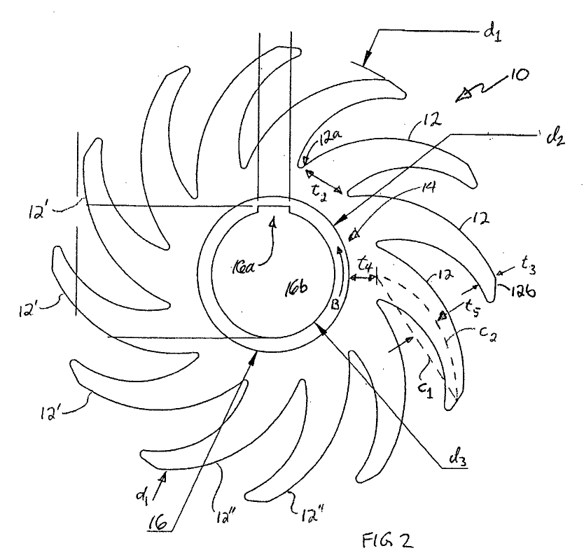

In a preferred embodiment, each of flanges 12 is curved rearwardly relative to direction of rotation B so that each flange 12, as best seen in FIG. 2, forms a scimitar-like shape. This assists in the application of a smooth downward pressure as upstream flanges 12′ rotate in direction B downwardly into contact with the upper surfaces of workpieces 18 translating under the flapper roll. Because of the scimitar-like shape, each of flanges 12 is precurved and thus flexing of each of the flanges 12 when downwardly biasing against a workpiece means that the continued curvature in the desired direction rather than a buckling of the flange will occur in a predetermined and desired fashion.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A flapper roll comprising:
a resilient substantially cylindrical core and extending radially outwardly therefrom a spaced array of resilient rearwardly cantilevered curved flapper flanges lying in a plane substantially containing a direction of flow of workpieces passing under the roll, wherein said flanges are rearwardly curved relative to a direction of rotation of the roll about a corresponding axis of rotation, said axis orthogonal to said plane, and wherein each flange of said flapper flanges is substantially flat across its width in a direction parallel to said axis so as to substantially evenly distribute across the width a resiliently biased downward force applied to the workpieces passing under the roll resulting from compression of said each flange as it engages the top surface of its corresponding workpiece to thereby substantially evenly hold down the workpiece and stabilize the workpiece directionally along its intended flow path.

2. The flapper roll of claim 1 wherein said flapper flanges have a hardness in a range of 40-100 Shore A.

3. The flapper roll of claim 1 wherein said flapper flanges are scimitar-shaped in side elevation profile.

4. The flapper roll of claim 3 wherein said each flange has a base formed with said core and an opposite distal end, opposite said base end, wherein said base end is thicker than said distal end.

5. The flapper roll of claim 1 wherein said roll has a diameter in said plane and extending across an outer circumference of said roll, and wherein said each flange has a length extending from and between its opposite ends and wherein said length is substantially one third of said diameter.

6. The flapper roll of claim 4 wherein said roll has a diameter in said plane and extending across an outer circumference of said roll, and wherein said each flange has a length extending from and between its opposite ends and wherein said length is substantially one third of said diameter.

7. The flapper roll of claim 5 wherein said length is a linear chord length extending from and between said opposite ends.

8. The flapper roll of claim 7 wherein said each flange has a curvature profile along the length of said each flange relative to said chord and wherein said curvature profile is defined by a maximum thickness substantially medially along said curvature, said maximum thickness between said curvature profile and said chord, and wherein a ratio of said maximum thickness to the length of said chord is substantially 1:6.

9. The flapper roll of claim 1 wherein, in said array, base ends of said flapper flanges abut one another in closely packed array around an outer circumference of said core.

10. The flapper roll of claim 9 wherein each flange of said flapper flanges is scimitar-shaped in side profile and tapers in said side profile from said base end to an opposite tip end so that a diverging gap is defined between adjacent said flanges whereby said tip ends are radially spaced apart from one another so that downstream flanges of said array may resiliently bias against a corresponding downstream workpiece passing under, and compressed downwardly by, said roll, and upstream flanges of said array, upstream from and adjacent to said downstream flanges, may engage against a leading edge of an upstream adjacent workpiece, which is upstream and next adjacent to said downstream workpiece, when said upstream workpiece is of a different thickness as compared to the thickness of said downstream workpiece.
